(19) United States
(12) Patent Application Publication
(10) Pub. No.: US 2013/0068598 A1
(43) Pub. Date: Mar. 21, 2013

(54) SLIDE SWITCH DEVICE

(71) Applicant: Shinya MUTO, Miyagi-ken (JP)

(72) Inventor: Shinya MUTO, Miyagi-ken (JP)

(73) Assignee: Alps Electric Co., Ltd., Ota-ku (JP)

(21) Appl. No.: 13/611,716

(22) Filed: Sep. 12, 2012

(30) Foreign Application Priority Data
Sep. 16, 2011 (JP) 2011-203157

(51) Int. Cl. H01H 15/02

(52) U.S. Cl. 200/329

(57) ABSTRACT

In a slide switch device in which a tactile-feel generation portion generates a tactile feel when a slider is operated to slide via an operation knob, the tactile-feel generation portion includes cam portions formed at a back surface of a flat plate portion of the slider, coil springs held at a guide base, and driving bodies that are elastically urged to the coil springs and are pressed to the cam portions. Elastic arms that elastically contact a guide flat surface of the guide base are provided at the flat plate portion of the slider. The elastic arms and the cam portions are arranged by the same number at positions separated from a shaft portion of the slider.

### CLAIM OF PRIORITY

This application contains subject matter related to and claims the benefit of Japanese Patent Application No. 2011-203157 filed on Sep. 16, 2011, the entire contents of which is incorporated herein by reference.

### BACKGROUND OF THE DISCLOSURE

1. Field of the Disclosure

The present disclosure relates to a slide switch device used for a power seat switch etc. that electrically operates a lumber support embedded in a vehicle seat.

2. Description of the Related Art

With a slide switch device used for a power seat switch etc. of an automobile, when a user operates an operation knob of in a desirable direction, a slider that moves in association with the operation knob performs a switching operation on a contact of a switch element, and a tactile feel that is generated by a tactile-feel generation mechanism is fed back to the user. Conventional slide switch devices that include the tactile feel generation mechanism have a tactile-feel adjustment tool that is fitted and fixed to a guide base with a slider mounted, the slider has a shaft portion integrated with an operation knob, a coil spring and a ball are housed and held directly below the shaft portion, and the ball is pressed to a cam groove of the tactile-feel adjustment tool by an elastic force of the coil spring (for example, see Japanese Unexamined Patent Application Publication No. 2010-251028). The slider has a plurality of legs that engage with a driving portion of a switch element, and the legs pinch the tactile-feel adjustment tool in the thickness direction. Accordingly, if the operation knob is operated and the slider slides on the guide base, the ball slides in the cam groove of the tactile-feel adjustment tool and the tactile feel is generated, and rattling of the slider in the thickness direction of the tactile-feel adjustment tool is reduced.

The slide switch device of the related art disclosed in Japanese Unexamined Patent Application Publication No. 2010-251028 reduces rattling of the slider in the thickness direction of the tactile-feel adjustment tool because the plurality of legs provided at the slider pinch the tactile-feel adjustment tool in the thickness direction. However, if the pinching force of the legs is excessively strong, a sliding resistance between the legs and the tactile-feel adjustment tool excessively increases, and the slider cannot be operated to smoothly slide. Hence, the legs have to contact the tactile-feel adjustment tool by a relatively small pinching force. In this case, when the ball at an initial position is pressed to a valley portion of the cam groove, the slider can be held in a state with small rattling. However, when the slider at the initial position is operated to slide and the ball is separated from the valley portion of the cam groove, the slider likely rattles in the sliding direction. In particular, if the slider can be operated to slide in multiple directions including two directions being orthogonal to each other, rattling likely occurs during the sliding operation of the slider. An operation feel may markedly deteriorate.

These and other drawbacks exist.

### SUMMARY OF THE DISCLOSURE

Embodiments of the present disclosure provide a slide switch device that restricts rattling of a slider and a good operation feel.

According to an embodiment of the present disclosure, a slide switch device includes a switch element; a slider that performs a switching operation on a contact of the switch element, the slider having a shaft portion, a bottom surface, and corner portions; a guide base that movably supports the slider; a casing that pinches the slider between the casing and the guide base; an operation knob integrated with the shaft portion of the slider, the shaft portion protruding from the casing; and a tactile-feel generation portion having an elastic body interposed between the guide base and the slider, the tactile-feel generation portion generating a tactile feel when the slider is operated to slide via the operation knob. The slider includes an elastic urging portion that is deformed when the elastic urging portion is pressed to the guide base. The elastic urging portion and the tactile-feel generation portion are arranged by the same number at positions separated from the shaft portion.

With such a slide switch device, when the slider is operated to slide in a desirable direction, the slider receives the elastic forces from the elastic urging portion and the tactile-feel generation portion in a well balanced manner and the slider slides on the guide base. Accordingly, rattling of the slider can be restricted and an operation feel can be improved.

Also, the elastic urging portion may be an elastic arm integrally formed with the slider in a cantilevered manner, and the tactile-feel generation portion may include a cam portion formed at the bottom surface of the slider, a coil spring being the elastic body and held at the guide base, and a driving body that is elastically urged to the coil spring and is pressed to the cam portion. Accordingly, the elastic arm being the elastic urging portion and the cam portion being a component of the tactile-feel generation portion can be precisely integrally formed with the slider.

In this case, when two lines having an intersection point at the shaft portion are set in a plane extending in a moving direction of the slider, two of the elastic arms may be formed on one of the lines at equal distances from the intersection point, and two of the cam portions may be formed on the other line at equal distances from the intersection point. Accordingly, the elastic arms and the cam portions can be arranged in a well balanced manner in the limited area of the slider.

Also, the slider may be movable in two directions being orthogonal to each other, and also the two cam portions may be formed in substantially conical recessed surfaces. Accordingly, the slider can be operated to slide smoothly in two different directions from the initial position. A multi-directional slide switch device with a good operation feel can be provided.

Also, the two elastic arms and the two cam portions may be formed at the corner portions of the slider. Accordingly, rattling of the slider can be efficiently restricted.

### BRIEF DESCRIPTION OF THE DRAWINGS

FIG. 1 is plan view of a seat switch unit on which a slide switch device according to an embodiment of the present disclosure is mounted;

FIG. 2 is an exploded perspective view of the seat switch unit according to an embodiment of the disclosure;

FIG. 3 is a cross-sectional view taken along line III-III in FIG. 1;

FIG. 4 is a plan view of a slider provided at the slide switch device in FIG. 1;

FIG. 5 is a cross-sectional view taken along line V-V in FIG. 4;

FIG. 6 is a cross-sectional view taken along line VI-VI in FIG. 4;

FIG. 7 is a perspective view when viewed from an upper surface of the slider;

FIG. 8 is a perspective view when viewed from a lower surface of the slider;

FIG. 9 is a plan view showing a state in which the slider is at an initial position on a guide base;

FIG. 10 is a cross-sectional view taken along line X-X in FIG. 9;

FIG. 11 is a plan view showing a state in which the slider is operated to slide on the guide base; and

FIG. 12 is a cross-sectional view taken along line XII-XII in FIG. 11.

### DETAILED DESCRIPTION OF THE DISCLOSURE

The following description is intended to convey a thorough understanding of the embodiments described by providing a number of specific embodiments and details involving a slide switch device. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

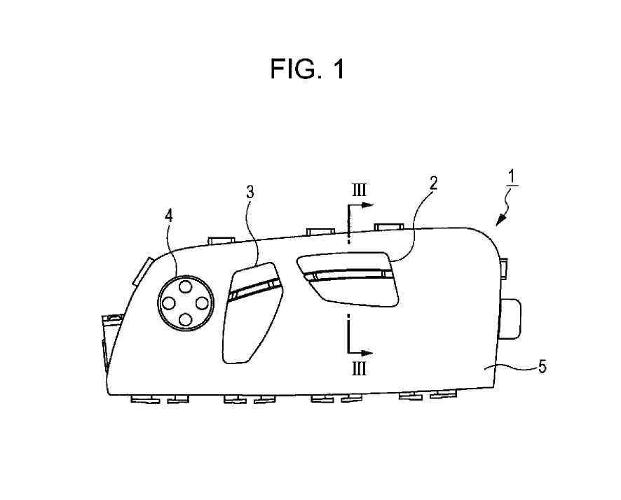

A seat switch unit 1 shown in FIG. 1 may operate a lumber support etc. embedded in a vehicle seat, and may be arranged on a side of a sitting part of the vehicle seat. An operation knob 2 for adjusting a front-rear position, a height position, etc., of the seat; an operation knob 3 for reclining adjustment; and an operation knob 4 for adjusting a protruding amount of a hip portion of a backrest may be arranged in line on the upper surface of the seat switch unit 1. A mechanism driven by the operation knob 2 may be a slide switch device according to the various embodiments of the present disclosure. In the following description, the slide switch device is described in detail, and description of switch devices driven by the other operation knobs 3 and 4 is omitted.

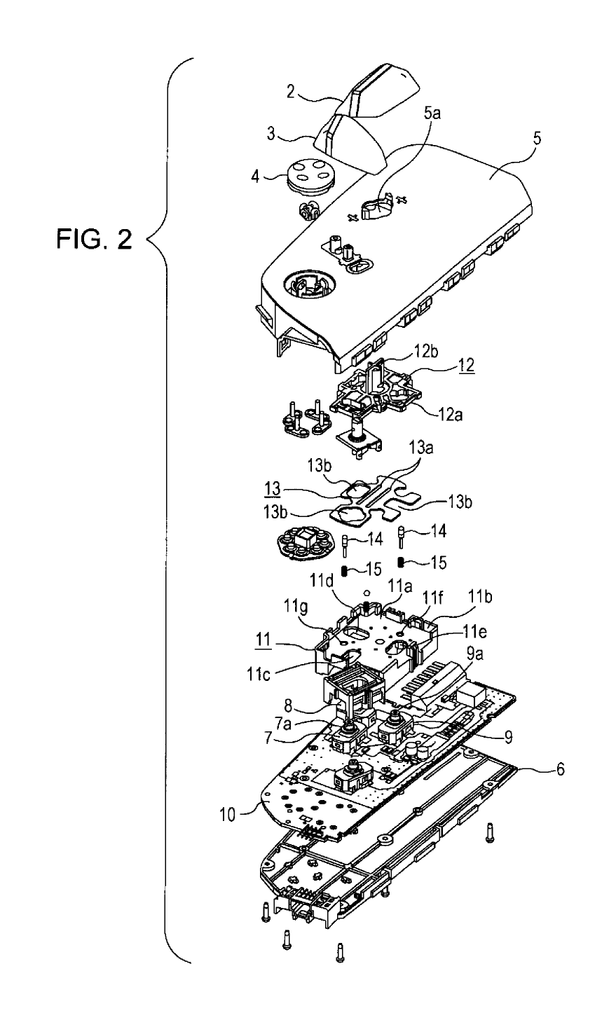

As shown in FIG. 2, the slide switch device according to an embodiment may include a casing 5 having a clearance hole 5a, the operation knob 2 arranged on an upper surface of the casing 5, a base body 6 that closes an opening at a lower surface of the casing 5, a circuit board 10 having a plurality of switch elements 7 to 9 etc. mounted thereon, a guide base 11 pinched between the casing 5 and the base body 6, a slider 12 pinched between the casing 5 and the guide base 11, a cam plate 13 engaging with a lower surface of the slider 12, a pair of driving bodies 14, and a pair of coil springs 15 etc.

The casing 5 and the base body 6 may be integrated by means for fixing such as screwing etc., and form an outer case. Components of the switch device except the operation knob 2 may be housed in an inner space defined by the casing 5 and the base body 6.

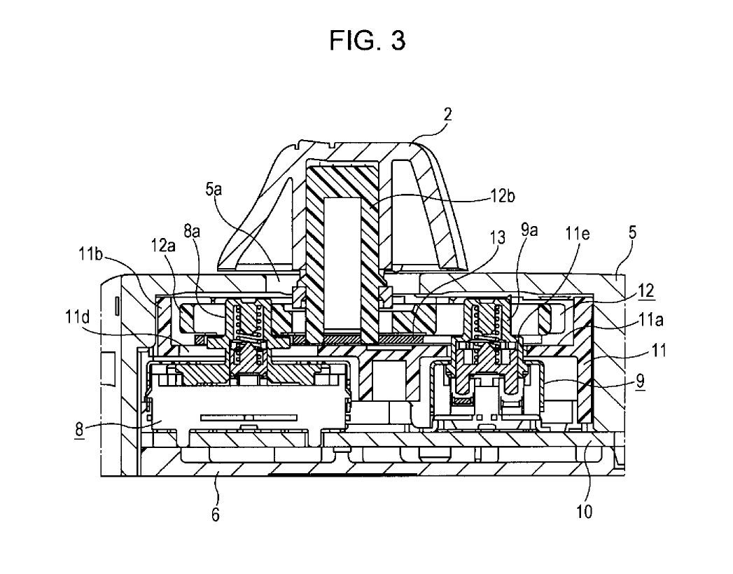

The circuit board 10 may be fixed to an upper surface of the base body 6. In addition to the three switch elements 7 to 9 operated by the operation knob 2, other switch elements operated by the operation knobs 3 and 4 may be mounted on the circuit board 10. The switch elements 7, 8, and 9 may be slide switches having stems 7a, 8a, and 9a protruding upward. When the stems 7a, 8a, and 9a are moved in directions orthogonal to the axes of the stems 7a, 8a, and 9a, embedded conductive plates (movable contacts) may move in a seesaw manner, to come into contact with and be separated from fixed contacts (see FIG. 3).

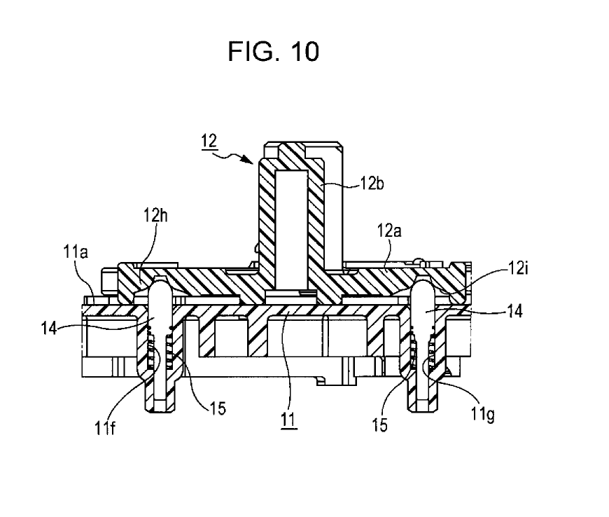

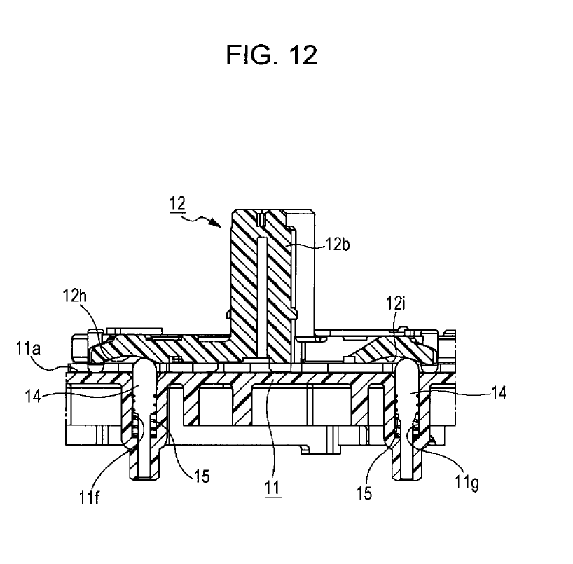

The guide base 11 may be a molded part made of synthetic resin having high smoothness. As shown in FIG. 2, a restriction wall 11b may be formed around a guide flat surface 11a having a substantially rectangular shape. The guide flat surface 11a may have therein three guide holes 11c, 11d, and 11e having track shapes. The longitudinal direction of the guide hole 11d, being one of the three guide holes 11c, 11d, and 11e, may be orthogonal to the longitudinal directions of the remaining two guide holes 11c and 11e. Also, the guide flat surface 11a may have therein two holding holes 11f and 11g. As shown in FIGS. 10 and 12, the holding holes 11f and 11g may have stepped shapes. The holding holes 11f and 11g respectively may house the rod-shaped driving bodies 14 with the coil springs 15 interposed. The driving bodies 14 may be urged to a lower surface of the slider 12 because the driving bodies 14 respectively may receive elastic forces of the corresponding coil springs 15.

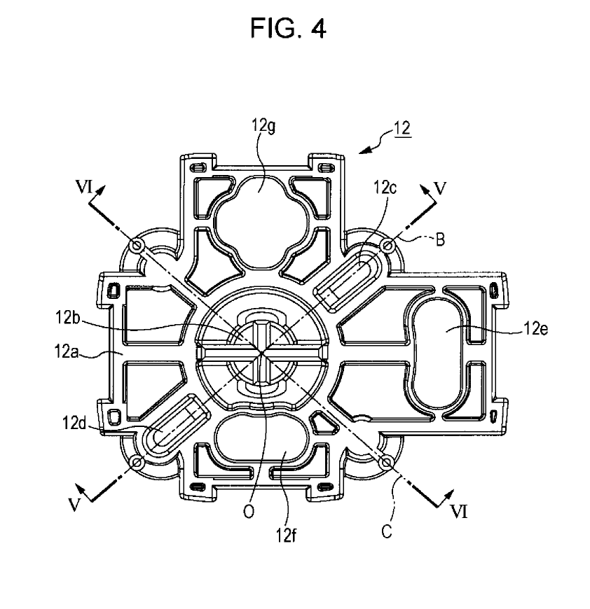

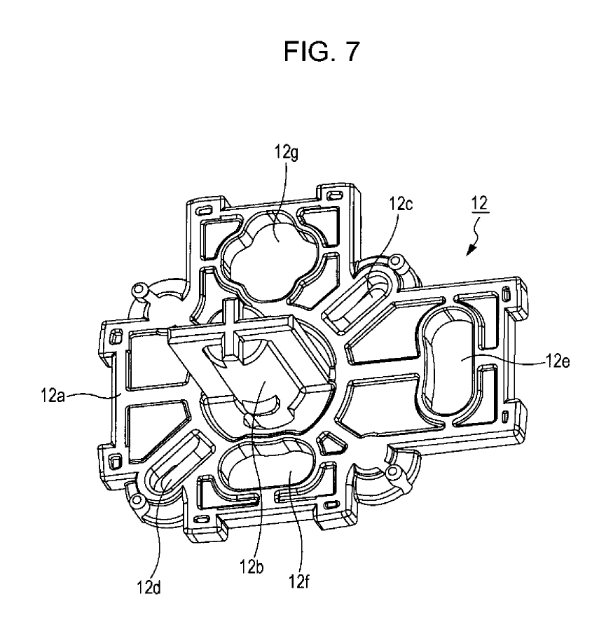

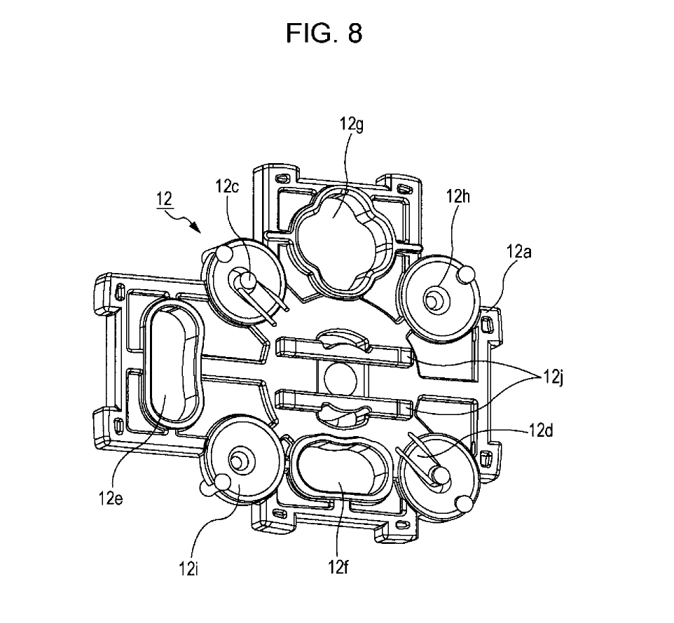

The slider 12 may be a molded part made of synthetic resin having good smoothness. As shown in FIGS. 4 to 8, the slider 12 may include a flat plate portion 12a extending in the horizontal direction, and a shaft portion 12b protruding upward from the flat plate portion 12a. The shaft portion 12b may be inserted into the clearance hole 5a and may protrude to the upper side of the casing 5. The operation knob 2 may be press-fitted to a distal end of the shaft portion 12b. Accordingly, the slider 12 and the operation knob 2 may be integrated (see FIG. 3). Two elastic arms 12c and 12d and three through holes 12e, 12f, and 12g may be formed at the flat plate portion 12a of the slider 12. Two cam portions 12h and 12i and a pair of guide rails 12j may be formed at a back surface of the flat plate portion 12a.

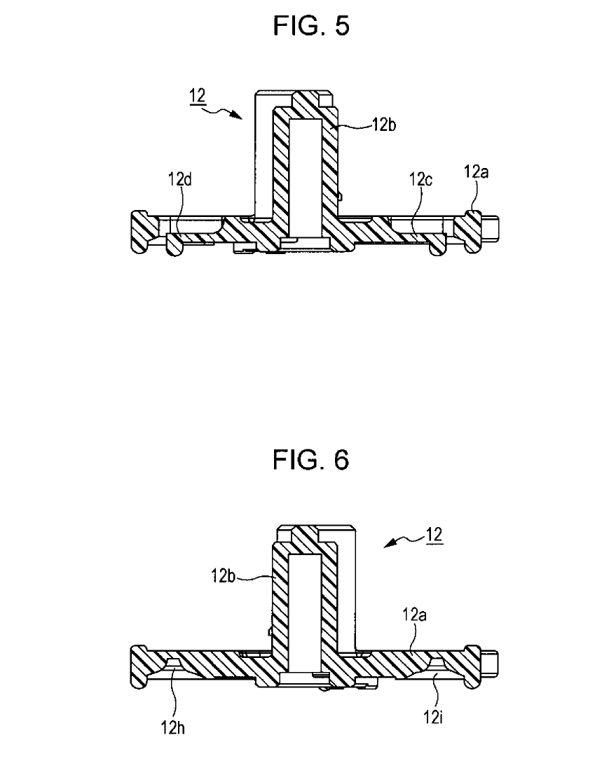

As shown in FIG. 5, the elastic arms 12c and 12d each may be an elastic urging portion that may be integrally formed with the flat plate portion 12a in a cantilevered manner. Distal ends (free ends) of the elastic arms 12c and 12d may be pressed to the guide flat surface 11a of the guide base 11, so that the flat plate portion 12a of the slider 12 receives elastic forces from the elastic arms 12c and 12d and may be urged to the lower surface of the casing 5. Also, the cam portions 12h and 12i may be substantially conically recessed surfaces (dented surfaces) and the lower sides of the cam portions 12h and 12i may be opened. A boundary portion between a valley portion formed at the center and a conical oblique surface of each of the cam portions 12h and 12i may have a shape that may generate the above-described tactile feel. The driving bodies 14 urged to the coil springs 15 respectively may be pressed to the cam portions 12h and 12i. The flat plate portion 12a of the slider 12 may be urged to the lower surface of the casing 5 while the flat plate portion 12a receives the elastic forces from the coil springs 15 in addition to the elastic forces from the elastic arms 12c and 12d. Two sets of tactile-feel generation portions may be formed by the cam portions 12h and 12i, and the corresponding driving bodies 14 and coil springs 15. Although the detail is described later, when the slider 12 is operated to slide in a desirable direction, a tactile feel (a click feel) may be generated from each of the tactile-feel generation portions.

As shown in FIG. 4, assuming that two lines B and C passing through the center 0 of the shaft portion 12b of the slider 12 and intersecting with each other are set, the elastic arms 12c and 12d may be arranged on the line B, and the cam portions 12h and 12i are arranged on the line C. The lines B and C substantially orthogonally intersect with each other. Distal ends of the elastic arms 12c and 12d and the centers (the valley portions) of the cam portions 12h and 12i may be alternately arranged at about 90 degrees on concentric circles around the shaft portion 12b.

The cam plate 13 may be formed by punching a metal flat seat into a predetermined shape. The cam plate 13 may have a pair of guide grooves 13a at the center and three relief portions 13b at the periphery. The cam plate 13 may be mounted on the guide flat surface 11a of the guide base 11. The guide rails 12j formed on the back surface of the flat plate portion 12a of the slider 12 respectively may engage with the corresponding guide grooves 13a of the cam plate 13. Accordingly, only when the slider 12 is operated to slide in an extending direction of the guide grooves 13a, the slider 12 may slide relative to the guide flat surface 11a and the cam plate 13. When the slider 12 is operated to slide in other direction, the slider 12 and the cam plate 13 may slide together on the guide flat surface 11a. Even if the relative positions of the slider 12 and the cam plate 13 are changed, the cam plate 13 does not overlap the distal ends of the elastic arms 12c and 12d, or the centers of the cam portions 12h and 12i.

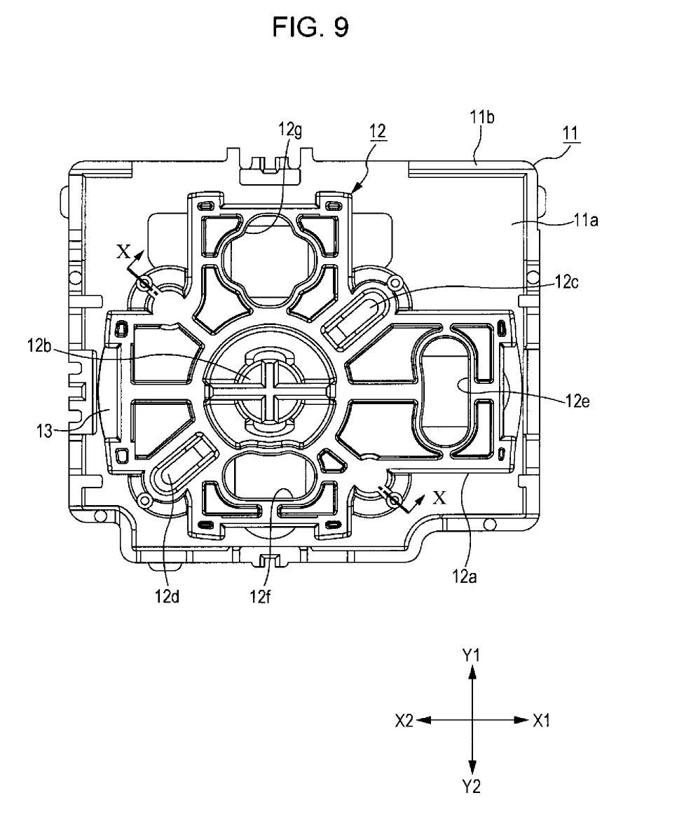

The above-described stems 7a, 8a, and 9a of the switch elements 7, 8, and 9 respectively may be inserted through the guide holes 11c, 11d, and 11e of the guide base 11 and the relief portions 13b of the cam plate 13, and then respectively may be inserted into and engage with the corresponding through holes 12e, 12f, and 12g of the slider 12. Accordingly, when the slider 12 is operated to slide in X1-X2 directions in FIG. 9, only the stem 7a engaging with the through hole 12e may slide in the same direction accordingly, and may perform a switching operation on the contact of the switch element 7. Also, when the slider 12 is operated to slide in Y1-Y2 directions in FIG. 9, only the stem 8a engaging with the through hole 12f slides in the same direction accordingly, and in this case, may perform a switching operation on the contact of the switch element 8. Further, when the slider 12 is operated to rotate around the shaft portion 12b in normal-reverse rotation directions by a predetermined angle, only the stem 9a engaging with the through hole 12g slides in the same direction accordingly, and in this case, may perform a switching operation on the contact of the switch element 9.

With such an embodiment of a slide switch device, as shown in FIG. 9, when the slider 12 may be at the initial position on the guide flat surface 11a of the guide base 11, the distal ends of the elastic arms 12c and 12d elastically contact the guide flat surface 11a, and the driving bodies 14 respectively may receive the elastic forces from the coil springs 15 and are pressed to the valley portions of the cam portions 12h and 12i (see FIG. 10). Hence, the flat plate portion 12a of the slider 12 may be elastically urged to the lower surface of the casing 5 in a well-balanced manner and may be held in a stable state by the elastic forces from the elastic arms 12c and 12d being the elastic urging portions, and the elastic forces from the coil springs 15 being the elastic bodies of the tactile-feel generation portions.

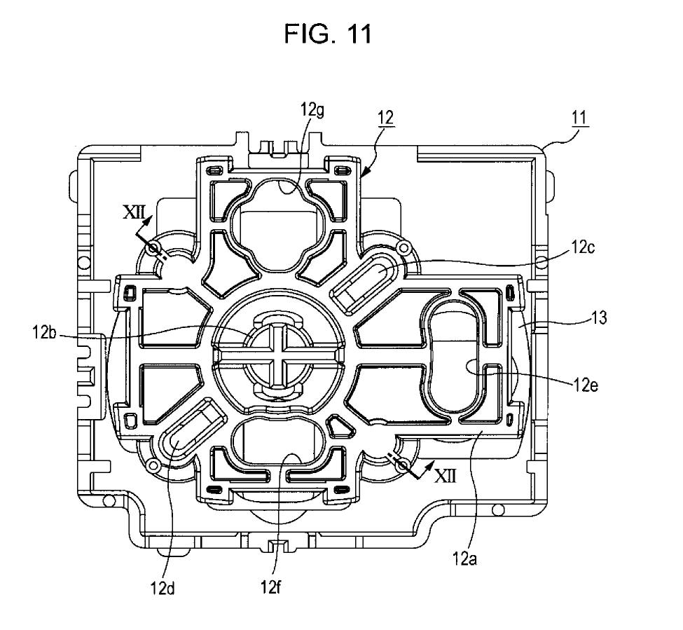

In this state, if the user operates the slider 12 via the operation knob 2 in a desirable direction, for example, in the Y1 direction in FIG. 9, the slider 12 and the cam plate 13 may slide together on the guide flat surface 11a in the same direction. Then, as shown in FIG. 11, the movement of the slider 12 in the same direction may be restricted at a position at which an outer edge of the flat plate portion 12a contacts the restriction wall 11b of the guide base 11. Meanwhile, since the slider 12 slides on the guide flat surface 11a while the slider 12 receives the elastic forces from the elastic arms 12c and 12d and the coil springs 15, rattling of the slider 12 may be restricted, and a good operation feel can be obtained. Also, when the slider 12 slides from the initial position in a desirable direction in this way, as shown in FIG. 12, the driving bodies 14 respectively may climb over the valley portions of the corresponding cam portions 12h and 12i and are shifted to the conical oblique surfaces. The tactile feel generated at this time is fed back to the user who manually operates the operation knob 2. When the slider 12 slides in the Y1 direction, the stem 8a engaging with the through hole 12f may be driven, and may perform a switching operation on the contact of the switch element 8. Hence, for example, the height position of the seat may be adjusted in response to a contact switch signal of the switch element 8.

When the slider 12 is operated to slide in a direction other than the Y1 direction in FIG. 9, the type and switch signal of the switch element 7, 8, or 9 driven in accordance with the sliding operation direction may differ from the above described type and switch signal. For example, when the slider 12 is operated to slide in the Y2 direction in FIG. 9, the stem 8a may be driven in a direction opposite to the above-described direction. In this case, the switch element 8 may output another contact switch signal. Also, when the slider 12 is operated to slide in the X1-X2 directions in FIG. 9, the slider 12 may slide relative to the guide flat surface 11a and the cam plate 13. In this case, the stem 7a engaging with the through hole 12e may be driven, and may perform a switching operation on the contact of the switch element 7. Hence, for example, the front-rear position of the seat may be adjusted in response to a contact switch signal of the switch element 7. Further, when the slider 12 is operated to rotate around the shaft portion 12b in the normal-reverse rotation directions by a predetermined angle, the slider 12 and the cam plate 13 may rotate together in the same direction on the guide flat surface 11a while sliding on the guide flat surface 11a. In this case, the stem 9a engaging with the through hole 12g may be driven and may perform a switching operation on the contact of the switch element 9. Hence, for example, the orientation of the seat may be adjusted in response to a contact switch signal of the switch element 9. Even in any of these cases, since the slider 12 slides on the guide flat surface 11a while the slider 12 receives the elastic forces from the elastic arms 12c and 12d and the coil springs 15, rattling of the slider 12 may be restricted, and a good operation feel can be obtained.

As described above, with the slide switch device according to an exemplary embodiment, the elastic urging portions (the elastic arms 12c and 12d) that are provided at the slider 12 and elastically contact the guide flat surface 11a of the guide base 11, and the tactile-feel generation portions (the cam portion 12h and 12i, the driving bodies 14, and the coil springs 15) that generate the tactile feel during the sliding operation of the slider 12 may be provided by the same numbers at the positions separated from the shaft portion 12b of the slider 12. Accordingly, when the slider 12 is operated to slide in a desirable direction, the slider 12 may slide on the guide flat surface 11a while the slider 12 receives the elastic forces from the elastic urging portions and the tactile-feel generation portions in a well balanced manner. Hence, rattling of the slider 12 may be restricted and the operation feel can be improved.

The elastic urging portions may be formed of the elastic arms 12c and 12d that are integrally formed in a cantilevered manner with the flat plate portion 12a of the slider 12; and the tactile-feel generation portions may be formed of the cam portions 12h and 12i formed at the back surface of the flat plate portion 12a of the slider 12, the coil springs (the elastic bodies) 15 held at the holding holes 11f and 11g of the guide base 11, and the driving bodies 14 that are elastically urged by the coil springs 15 and hence pressed to the cam portions 12h and 12i. The elastic urging portions (the elastic arms 12c and 12d) and part of the components of the tactile-feel generation portions (the cam portions 12h and 12i) can be precisely integrally formed with the slider 12 made of synthetic resin.

Then, when the two lines intersecting with each other at the intersection point 0 that is the shaft portion 12b are set in the plane extending along the moving directions of the slider 12, the two elastic arms 12c and 12d may be formed on one of the lines at equal distances from the intersection point O, and the two cam portions 12h and 12i are formed on the other line at equal distances from the intersection point O. Accordingly, the two elastic arms 12c and 12d and the two cam portions 12h and 12i can be arranged in a well balanced manner in the limited area of the slider 12. Also, the slider 12 may move in the two directions (the X and Y directions) being orthogonal to each other, and the two cam portions 12h and 12i are formed in conical shapes. Accordingly, the slider 12 can be operated to smoothly slide in the two different directions from the initial position. A multi-directional slide switch device with a good operation feel can be provided.

Described in the above-described embodiment is the slide switch device in which the slider 12 can move in the two directions being orthogonal to each other (the X and Y directions) and in the rotation direction around the shaft portion 12b. However, the slide switch device in which the slider 12 can move only in the two directions being orthogonal to each other (the X and Y directions) or only in one of the X and Y directions may be provided. In this case, the cam plate 13 may be omitted.

Also, in the above-described embodiment, the cam portions 12h and 12i of the tactile-feel generation portions may be the substantially conical recessed surfaces (the dented surfaces). However, the shapes of the cam portions may be properly changed in accordance with the operation direction of the slider 12. For example, if the slider 12 can move only in the two directions being orthogonal to each other, the cam portion may be a dent with a cross-like shape in plan view. Also, the cam portions 12h and 12i press the rod-shaped driving bodies 14. However, balls serving as the driving bodies may be pressed to the cam portions 12h and 12i.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A slide switch device, comprising:
a switch element having a contact;
a slider that performs a switching operation on the contact of the switch element, the slider having a shaft portion, a bottom surface, and corner portions;
a guide base that movably supports the slider;
a casing that pinches the slider between the casing and the guide base;
an operation knob integrated with the shaft portion of the slider, the shaft portion protruding from the casing; and
a tactile-feel generation portion having an elastic body interposed between the guide base and the slider, the tactile-feel generation portion generating a tactile feel when the slider is operated to slide via the operation knob,
wherein the slider includes an elastic urging portion that is deformed when the elastic urging portion is pressed to the guide base, and
wherein the elastic urging portion and the tactile-feel generation portion are arranged by the same number at positions separated from the shaft portion.

2. The slide switch device according to claim 1,
wherein the elastic urging portion is an elastic arm integrally formed with the slider in a cantilevered manner, and
wherein the tactile-feel generation portion includes
a cam portion formed at the bottom surface of the slider,
a coil spring being the elastic body and held at the guide base, and
a driving body that is elastically urged to the coil spring and is pressed to the cam portion.

3. The slide switch device according to claim 2, wherein when two lines having an intersection point at the shaft portion are set in a plane extending in a moving direction of the slider, two of the elastic arms are formed on one of the lines at equal distances from the intersection point, and two of the cam portions are formed on the other line at equal distances from the intersection point.

4. The slide switch device according to claim 3,
wherein the slider is movable in two directions being orthogonal to each other, and
wherein the two cam portions are formed in substantially conical recessed surfaces.

5. The slide switch device according to claim 3, wherein the two elastic arms and the two cam portions are formed at the corner portions of the slider.
